(19) United States
(12) Patent Application Publication
(10) Pub. No.: US 2017/0328425 A1
(43) Pub. Date: Nov. 16, 2017

(54) FRICTION BRAKING SYSTEM

(71) Applicant: Hyperloop Technologies, Inc., Los Angeles, CA (US)

(72) Inventors: Chiranjeev KALRA, Niskayuna, NY (US); Tadeh AVETIAN, Burbank, CA (US); Andrew LAWSON, San Marino, CA (US); Rehman QURESHI, Dothan, AL (US); Robert STELLER, Los Angeles, CA (US); Thomas DUSSEAULT, Los Angeles, CA (US)

(73) Assignee: Hyperloop Technologies, Inc., Los Angeles, CA (US)

(21) Appl. No.: 15/591,452

(22) Filed: May 10, 2017

Related U.S. Application Data
(60) Provisional application No. 62/401,545, filed on Sep. 29, 2016.
(60) Provisional application No. 62/349,894, filed on Jun. 14, 2016.
(60) Provisional application No. 62/334,175, filed on May 10, 2016.

(51) Int. Cl. F16D 63/00; F16D 69/02; F16D 65/06; B61H 7/12; F16D 121/04; F16D 125/58; F16D 125/64

(52) U.S. Cl. CPC F16D 63/008; F16D 65/06; F16D 69/023; B61H 7/12; F16D 2125/582; F16D 2125/64; F16D 2121/04

(57) ABSTRACT

A friction-braking apparatus for a transportation system, having at least one caliper, at least one piston structured and arranged to move the at least one caliper; and at least one brake pad arranged on the at least one caliper. The at least one caliper is structured and arranged to selectively move the at least one brake pad into engagement with at least one rail of the transportation system.

### CROSS-REFERENCE TO RELATED APPLICATIONS

The present application claims the benefit of U.S. Provisional Application No. U.S. Provisional Application No. 62/334,175, filed May 10, 2016, U.S. Provisional Application No. 62/349,894, filed Jun. 14, 2016, and U.S. Provisional Application No. 62/401,545, filed Sep. 29, 2016, the contents of which are expressly incorporated herein by reference in their entireties.

### BACKGROUND OF THE DISCLOSURE

### 1. Field of the Disclosure

The present disclosure relates to a friction braking system, and more particularly to a friction braking system for a low-pressure (or evacuated) tube transportation system.

### 2. General Background and State of the Art

The primary goal of transportation is “to go.” At first, to go simply indicates moving. Over time, “to go” is refined to moving with purpose—getting from point A to point B. Implied in moving with purpose, no matter what mode of transportation used, is that the journey will ultimately stop. Therefore, while “to go” is the primary goal of transportation, “to stop” is the ultimate goal.

Newton's Laws of Motion dictate that an opposite force is necessary to slow a body in motion. Applying this law to transportation, the faster a vehicle is travelling, the greater the braking force necessary in order to stop the vehicle. For each of the major modes of modern transportation, for example, cars, planes, trains, boats, a plurality of methods for stopping are employed. For example, a driver can slow a car by applying brakes directly to the wheels, by shifting to a lower gear, and/or by coasting, which allows naturally occurring slowing forces (such as air resistance and/or friction) to slow the car. A pilot can slow a plane in the air by increasing air resistance, for example, through the use of speed brakes and flaps and/or by lowering the landing gear. While taxiing, a pilot can slow a plane by using wheel brakes, by increasing air resistance, and by applying a reverse thrust. In order to slow a train, for example, an engineer can apply brakes directly to the wheels. In order to slow a ship, a captain can increase drag, can change direction, and/or can apply a reverse thrust.

Although a vehicle will eventually stop due to friction created between the vehicle and the surface the vehicle is travelling on (or in), in order to provide a reasonable and safe mode of transportation, the vehicle should be able to stop on demand. This can pose a particularly difficult hurdle for the development of high-speed transportation in a low-pressure environment.

Most of the current forms of braking are dependent on the vehicle making physical contact with a surface on which it is travelling. In situations where the vehicle does not make contact with a surface, however, such as a levitating vehicle, there must be some other way to apply a brake force to the vehicle. Accordingly, there is a need for an improved braking system.

Furthermore, typical braking methods operate by creating friction between two surfaces, converting the kinetic energy of the moving vehicle into heat. Friction braking, however, tends to be difficult to implement for certain types of transportation. For example, in high-speed transportation, the vehicle has an immense amount of kinetic energy, therefore the use of friction braking will create high amounts of heat, which in turn may damage the vehicle or the surface the vehicle is travelling on (and/or adjacent to), and which in turn may require constant repairs to both the high-speed vehicle and the surface the vehicle is travelling on (and/or adjacent to). Current practices do not provide a mechanism capable of creating a sustainable frictional braking system designed to handle the speed of a high-speed transportation system. Accordingly, there are needs for an improved braking system.

Additionally, typical frictional braking methods require a substantially linear range of movement and do not account for nonlinear paths and/or vibrations of the vehicle. For example, the brake pads used in frictional braking are typically affixed to rigid plates that are restricted to moving in a single plane that cannot rotate or pivot about an axis. This constraint can limit the distance or terrain and/or track configurations the vehicle is able to traverse, as well as create very tight tolerances for brake rail deviation. Accordingly, there are further needs for an improved braking system that can compensate for nonlinear paths (e.g., track deflections).

Current practices do not provide a mechanism capable of creating a sustainable frictional braking system designed to handle the speed and/or movement (e.g., deflection) encountered with a high-speed transportation system.

Accordingly, there exists needs in the art for an improved braking system for a high-speed transportation system.

### SUMMARY OF THE EMBODIMENTS OF THE DISCLOSURE

The novel features which are characteristic of the disclosure, both as to structure and method of operation thereof, together with further aims and advantages thereof, will be understood from the following description, considered in connection with the accompanying drawings, in which the preferred embodiment of the disclosure is illustrated by way of example. It is to be expressly understood, however, that the drawings are for the purpose of illustration and description only, and they are not intended as a definition of the limits of the disclosure.

Embodiments of the present disclosure are directed to a friction-braking apparatus for a transportation system, comprising at least one caliper, at least one piston structured and arranged to move the at least one caliper, and at least one brake pad arranged on the at least one caliper. The at least one caliper is structured and arranged to selectively move the at least one brake pad into engagement with at least one rail of the transportation system.

In some embodiments, the friction-braking apparatus further comprises at least one mounting plate arranged on an end of the at least one caliper, wherein the at least one brake pad is arranged on the at least one mounting plate.

In further embodiments, the friction-braking apparatus further comprises a mating material arranged on at least portions of the at least one rail.

In additional embodiments, the at least one caliper comprises at least two calipers, and the at least one piston is structured and arranged to move the at least two calipers so as to selectively move the at least one brake pad into engagement with at least one rail of the transportation system.

In yet further embodiments, the at least one caliper comprises at least two calipers, and the at least one piston is structured and arranged to move the at least two calipers so as to selectively move respective brake pads into engagement with at least one rail of the transportation system.

In some embodiments, the at least one brake pad comprises carbon-reinforced carbon.

In some embodiments, the at least one brake pad comprises sintered metal.

In some embodiments, the at least one brake pad comprises sintered composite.

In further embodiments, the at least one brake pad comprises an array of brake pads arranged on the at least one mounting plate.

In additional embodiments, the friction-braking apparatus further comprises a support structure having first and second pivots structured and arranged for pivotally supporting respective calipers.

In yet further embodiments, the support structure further comprises a plurality of mounting holes structured and arranged for a connection to a vehicle of the transportation system.

In some embodiments, the friction-braking apparatus further comprises elastomer elements arranged in respective mounting holes of the support structure.

In further embodiments, the friction-braking apparatus further comprises at least one Belleville washer arranged between the mounting plate and the at least one brake pad.

In additional embodiments, the friction-braking apparatus further comprises at least one gimbal arranged between the mounting plate and the at least one piston.

In yet further embodiments, the at least one piston comprises two pistons.

In some embodiments, the friction-braking apparatus further comprises a supply line connecting with respective balance lines of the two pistons, wherein the respective balance lines are structured and arranged so cooperatively engage the two pistons in a compensating manner.

In further embodiments, the friction-braking apparatus further comprises an array of disk springs, and an array of backing plates, wherein the array of disk springs are arranged in contact with the at least one mounting plate and in respective contact with the array of backing plates, and wherein the array of brake pads are respectively arranged on the array of backing plates.

In additional embodiments, the friction-braking apparatus is configured to limit the amount of heat created when reducing a velocity of a vehicle of the transportation system.

Further embodiments of the present disclosure are directed to a transportation tube for a transportation system comprising at least one brake rail structured and arranged for engagement with the at least one friction braking apparatus.

Certain embodiments of the present disclosure are directed to a vehicle for a high-speed transportation system comprising at least one friction braking apparatus.

Yet further embodiments of the present disclosure are directed to a method of operating a friction-braking apparatus for a vehicle in a tubular structure of a tubular transportation system, the method comprising selectively moving at least one brake pad of the friction-braking apparatus into engagement with at least one rail of the transportation system arranged on an interior wall of the tubular structure.

In some embodiments, the at least one brake pad comprises at least two brake pads arranged on opposite sides of the at least one rail of the transportation system, and the friction-braking apparatus comprises balance lines structured and arranged so cooperatively engage the at least two brake pads arranged on opposite sides of the at least one rail in a compensating manner, The method further comprises cooperatively engaging the at least two brake pads arranged on opposite sides of the at least one rail in the compensating manner.

In some embodiments, the friction-braking apparatus comprises at least one mounting plate arranged on an end of at least one caliper, wherein the at least one brake pad is arranged on the at least one mounting plate and at least one gimbal is arranged between the mounting plate and the at least one brake pad

Additional aspects of the present disclosure are related to a mechanism for braking comprising at least one braking assembly and at least one mating material. The at least one braking assembly may comprise at least one caliper, at least one brake pad, and at least one hydraulic piston. In one embodiment, the at least one brake pad may be located on the at least one caliper. The at least one hydraulic piston may be connected to the at least one caliper, such that the at least one hydraulic piston may control the at least one caliper. In one embodiment, the at least one brake pad may be comprised of carbon-reinforced carbon. The at least one braking assembly may be installed on a vehicle. The at least one mating material may comprise a surface the vehicle is traveling on. In one embodiment, the at least one hydraulic piston may cause the at least one caliper to contact the at least one mating material, forcing the at least one brake pad to press upon the mating material, such that a friction is created between the at least one mating material and the at least one brake pad. In accordance with aspects of the disclosure, the friction leads to a decrease in the velocity of the vehicle.

Further aspects of the present disclosure are related to a linear friction braking apparatus configured to slow a vehicle. The braking apparatus may comprise a friction braking material, one or more disk springs, one or more shear pins, one or more structural mounting plates, one or more lever arms, one or more elastomers, a backing plate, and a hydraulic actuator.

Additional aspects of the present disclosure are directed to a mechanism for braking comprising at least one brake rail and at least one caliper. In embodiments, the at least one brake rail may comprise metal. In some embodiments, the at least one brake rail may be composed of metal. The at least one brake rail may be affixed to the surface the vehicle is travelling on. The at least one caliper may comprise two braking assemblies and a bypass line. In an exemplary and non-limiting embodiment, each of the two braking assemblies may comprise at least one cylinder, at least one gimbal, at least one brake pad, at least one plate, at least one Belleville washer or coned-disc spring (a type of spring shaped like a washer, with a frusto-conical shape), a first bolt (or piston rod), and a second bolt. The cylinder may be located on the distal portion of the braking assembly. The cylinder may comprise, but is not limited to, a hydraulic or pneumatic cylinder. The first bolt may extend from a proximal surface of the cylinder and terminate in the at least one gimbal. The at least one gimbal may connect the first bolt to a distal surface of the at least one plate. The at least one brake pad may be located on a proximal portion of the at least one plate. The at least one brake pad may be rigidly affixed to a proximal surface of the at least one plate via the at least one Belleville washer and the second bolt, such that the at least one Belleville washer is positioned substantially between the at least one plate and the at least one brake pad with the second bolt securing the at least one brake pad in place. The at least one brake pad may be made of a material comprising, but not limited to, a carbon-reinforced carbon, a sintered metal, or a combination of a carbon-reinforced carbon and a sintered metal.

### BRIEF DESCRIPTION OF THE DRAWINGS

These and other features of this disclosure will be best understood by reference to the following detailed description of a preferred embodiment of the invention, taken in conjunction with the accompanying drawings, in which:

FIG. 1 shows elements of an exemplary and non-limiting pod-transportation system including a tube, brake rails, and a track in accordance with aspects of the disclosure;

FIG. 2 shows elements of the pod-transportation system further including a schematically-depicted pod, wherein the pod comprises a plurality of braking apparatuses in accordance with aspects of the disclosure;

FIG. 3 the schematically-depicted pod having a plurality of exemplary braking apparatuses in accordance with aspects of the disclosure;

FIG. 4 shows an exemplary and braking apparatus contacting a brake rail in order to slow down the pod in accordance with aspects of the disclosure;

FIG. 5 shows the exemplary braking apparatus in a first position in accordance with aspects of the disclosure;

FIG. 6 shows the exemplary braking apparatus in a second position in accordance with aspects of the disclosure;

FIG. 7 shows an exploded view of elements of the exemplary braking apparatus in accordance with aspects of the disclosure;

FIG. 8 shows an exploded view of elements of the braking apparatus in accordance with aspects of the disclosure;

FIG. 9 shows an isometric view of elements of the braking apparatus in accordance with aspects of the disclosure;

FIG. 10 shows an isometric view of the exemplary braking apparatus in accordance with aspects of the disclosure;

FIG. 11 shows a schematically-depicted cross-sectional view of an exemplary braking assembly in accordance with aspects of the disclosure;

FIG. 12 shows a schematically-depicted cross-sectional view of an exemplary braking assembly in accordance with aspects of the disclosure;

FIGS. 13A and 13B show a side view and a front perspective view of an exemplary braking apparatus in accordance with aspects of the disclosure;

FIG. 14 shows a schematically-depicted cross-sectional view of an exemplary braking apparatus in accordance with aspects of the disclosure;

FIG. 15 shows a view of an exemplary braking apparatus in accordance with aspects of the disclosure;

FIG. 16 shows a cross-sectional view of elements of an exemplary braking apparatus in accordance with aspects of the disclosure; and

FIG. 17 is an exemplary system for use in accordance with the embodiments described herein.

### DETAILED DESCRIPTION OF THE EMBODIMENTS OF THE DISCLOSURE

In the following description, the various embodiments of the present disclosure will be described with respect to the enclosed drawings. As required, detailed embodiments of the embodiments of the present disclosure are discussed herein; however, it is to be understood that the disclosed embodiments are merely exemplary of the embodiments of the disclosure that may be embodied in various and alternative forms. The figures are not necessarily to scale and some features may be exaggerated or minimized to show details of particular components. Therefore, specific structural and functional details disclosed herein are not to be interpreted as limiting, but merely as a representative basis for teaching one skilled in the art to variously employ the present disclosure.

The particulars shown herein are by way of example and for purposes of illustrative discussion of the embodiments of the present disclosure only and are presented in the cause of providing what is believed to be the most useful and readily understood description of the principles and conceptual aspects of the present disclosure. In this regard, no attempt may be made to show structural details of the present disclosure in more detail than is necessary for the fundamental understanding of the present disclosure, such that the description, taken with the drawings, making apparent to those skilled in the art how the forms of the present disclosure may be embodied in practice.

As used herein, the singular forms “a,” “an,” and “the” include the plural reference unless the context clearly dictates otherwise. For example, as used herein, the indefinite article “a” indicates one as well as more than one and does not necessarily limit its referent noun to the singular. Thus, for example, reference to “a magnetic material” would also indicate that mixtures of one or more magnetic materials can be present unless specifically excluded.

Except where otherwise indicated, all numbers expressing quantities used in the specification and claims are to be understood as being modified in all instances by the term “about.” Accordingly, unless indicated to the contrary, the numerical parameters set forth in the specification and claims are approximations that may vary depending upon the desired properties sought to be obtained by embodiments of the present disclosure. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range (unless otherwise explicitly indicated). For example, if a range is from about 1 to about 50, it is deemed to include, for example, 1, 7, 34, 46.1, 23.7, or any other value or range within the range.

As used herein, the terms “about” and “approximately” indicate that the amount or value in question may be the specific value designated or some other value in its neighborhood. Generally, the terms “about” and “approximately” denoting a certain value is intended to denote a range within ±5% of the value. As one example, the phrase “about 100” denotes a range of 100±5, i.e. the range from 95 to 105. Generally, when the terms “about” and “approximately” are used, it can be expected that similar results or effects according to the disclosure can be obtained within a range of ±5% of the indicated value.

The term “at least partially” is intended to denote that the following property is fulfilled to a certain extent or completely.

The terms “substantially” and “essentially” are used to denote that the following feature, property or parameter is either completely (entirely) realized or satisfied or to a major degree that does not adversely affect the intended result.

The term “substantially parallel” refers to deviating less than 20° from parallel alignment and the term “substantially perpendicular” refers to deviating less than 20° from perpendicular alignment. The term “parallel” refers to deviating less than 5° from mathematically exact parallel alignment. Similarly “perpendicular” refers to deviating less than 5° from mathematically exact perpendicular alignment.

The term “comprising” as used herein is intended to be non-exclusive and open-ended. Thus, for instance a composition comprising a compound A may include other compounds besides A. However, the term “comprising” also covers the more restrictive meanings of “consisting essentially of” and “consisting of,” so that for instance “a composition comprising a compound A” may also (essentially) consist of the compound A.

As used herein, the term “and/or” indicates that either all or only one of the elements of said group may be present. For example, “A and/or B” shall mean “only A, or only B, or both A and B”. In the case of “only A”, the term also covers the possibility that B is absent, i.e. “only A, but not B.”

The various embodiments disclosed herein can be used separately and in various combinations unless specifically stated to the contrary.

Embodiments of the present disclosure may be used in a transportation system, for example, as described in commonly-assigned application Ser. No. 15/007,783, titled “Transportation System,” the contents of which are hereby expressly incorporated by reference herein in their entirety.

Aspects of the present disclosure are directed to braking systems for a high-speed transportation system, for example, useable in conjunction with a levitating vehicle, in which the vehicle may not make contact with a “braking surface” (e.g., a surface on which the vehicle is travelling and that is contacted by the vehicle) during travel. Thus, implementing aspects of the disclosure provides an improved braking system for transportation systems in which a levitating vehicle may not make contact with a track surface. By implementing further aspects of the disclosure, a high-speed transportation vehicle in a low-pressure environment may be provided a braking mechanism capable of and operable to create a sustainable frictional braking system designed to handle the speed of a high-speed transportation system. Implementing further aspects of the disclosure provides an improved braking system that is operable to compensate for nonlinear paths (e.g., track deflections).

FIG. 1 shows elements of an exemplary and non-limiting high-speed transportation system including a tube (or tubular structure) 100, having one or more brake rails, and a track in accordance with aspects of the disclosure. More specifically, FIG. 1 shows an exemplary sectional perspective view of an embodiment of a tubular structure 100 comprising a plurality of brake rails and a track 103 in accordance with aspects of the disclosure. With this exemplary and non-limiting embodiment, the brake rails comprise a first brake rail 101 on one side of the tube 100 and a second brake rail 102 on an opposing side of the tube 100. In accordance with aspects of the disclosure, a plurality of the tubular structures 100 may be configured as a transportation path for a high-speed transportation system, in which the track 103 is configured to accelerate (and/or decelerate) a vehicle (or capsule or pod) of the transportation system.

For example, the braking system may be implemented on a high-speed vehicle configured for travelling in a tube formed of the tubular structures 100, as shown in FIG. 1. The braking system, apparatus, or assembly may comprise respective calipers (not shown) structured and arranged to selectively interact with one or more brake rails. As shown in FIG. 1, each of the two brake rails 101, 102 may be structured and arranged to be horizontally affixed (e.g., welded and/or bolted) to the sides of the tubular structures 100, such that each side of the tube 100 has a respective brake rail affixed to it. Additionally, in this exemplary embodiment, the at least two calipers (not shown) may be configured such that at least one caliper is affixed to each side of the vehicle. The at least two calipers (not shown) are positioned such that the brake pad of each braking assembly is contactable with engagement surfaces of the corresponding brake rail (e.g., brake rail nearest to it).

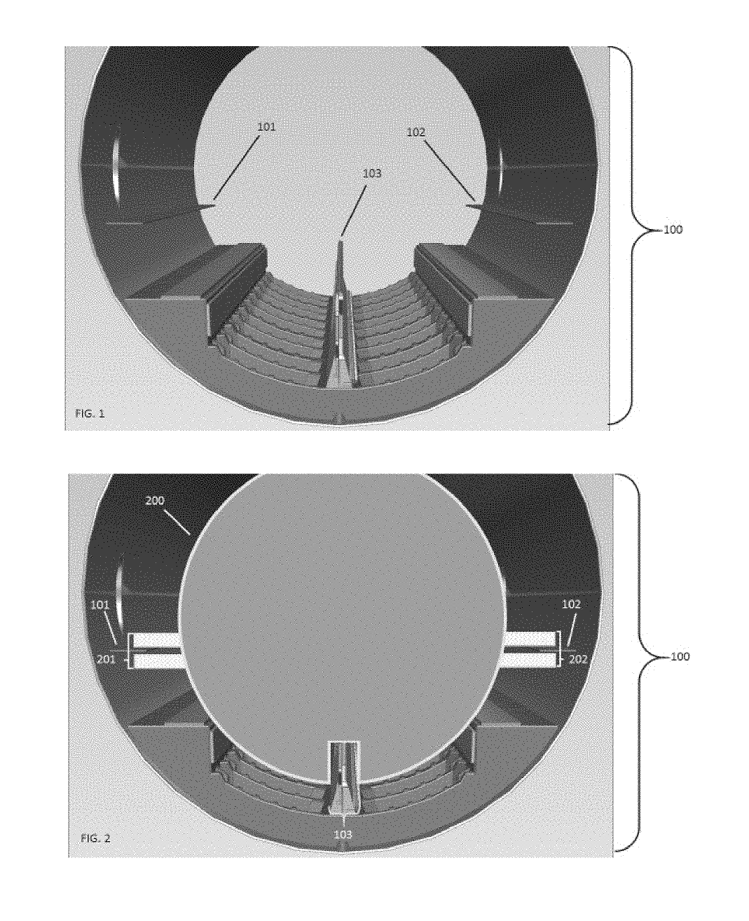

FIG. 2 shows elements of the pod-transportation system further including a schematically-depicted pod 20, wherein the pod 20 comprises a plurality of braking apparatuses in accordance with aspects of the disclosure. As shown in FIG. 2, an exemplary schematic depiction of a pod 200 is depicted traveling along the track 103 of the tubular structure 100. The pod (or capsule) 200 may comprise a plurality of friction braking apparatuses. As shown in FIG. 2, the plurality of friction braking apparatuses may comprise a first braking apparatus 201 on one side of the pod 200, and a second braking apparatus 202 on an opposite side of the pod 200.

When the pod 200 is in operation (e.g., moving through the tube 100 along the track 103), the first and second braking apparatuses 201, 202 may not be in contact with the first and second brake rails 101, 102. When the pod 200 is to be slowed, however, the first and second braking apparatuses 201, 202 can be applied. When applied (or closed), elements (e.g., brake pads) of the first braking apparatus 201 move into contact with the first brake rail 101, creating a first frictional force that opposes the motion of the pod 200. Additionally, when applied, elements (e.g., brake pads) of the second braking apparatus 202 move into contact with the second brake rail 102 creating a second frictional force that opposes the motion of the pod 200. In accordance with aspects of the disclosure, the first and second frictional forces act to slow down the pod 200.

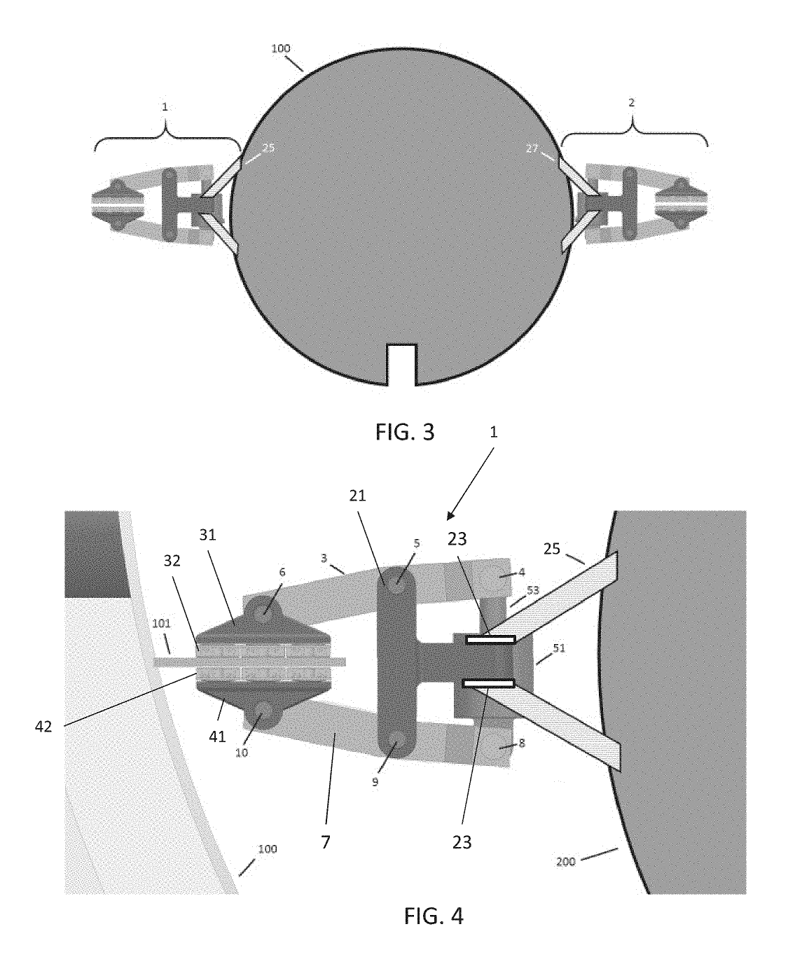

FIG. 3 shows an exemplary and non-limiting pod comprising a plurality of braking apparatuses in accordance with aspects of the disclosure. More specifically, FIG. 3 shows the pod 200 and a first hydraulically-actuated clamp 1. A first linkage 25 and a second linkage (not shown) may attach the first hydraulically-actuated clamp 1 to the pod 200. FIG. 3 further shows how the pod 200 may additionally comprise a second hydraulic actuated clamp 2 connected to the pod 200 via a third linkage 27 and a fourth linkage (not shown).

Alternatively to being fixed to the pod 200, in some embodiments (not shown), the first linkage 25, the second linkage (not shown), the third linkage 27, and the fourth linkage may be pivotally attached to the pod 200 (e.g., using pivots). In accordance with aspects of the disclosure, the pivotable attachment allows the first and second hydraulic actuated clamps 1, 2 to accommodate greater variations in pod displacement relative to the first and second brake rails 101, 102.

FIG. 4 shows an exemplary braking apparatus 1 contacting a brake rail 101 to slow down the pod 200 in accordance with aspects of the disclosure. As shown in FIG. 4, the hydraulic actuated clamp 1 comprises a plurality of lever arms (or calipers) 3, 7, a brake support structure 21, an actuator 51, a plurality of mounting plates 31, 41, a first plurality of disk springs 36, a second plurality of disk springs 46, a first plurality of brake pads 32, and a second plurality of brake pads 42.

In accordance with aspects of the disclosure, the structural mounting plates may be connected to respective actuation arms (or calipers) that having at least one pivot connected to the vehicle. A linear hydraulic actuator may be connected to the actuation arms. When in operation, the actuator is structured and arranged to cause the structural mounting plate and the one or more brake pads to clamp down on the rail.

As shown in FIG. 4, with the exemplary and non-limiting embodiment, the plurality of mounting plates comprises a first mounting plate 31 and a second mounting plate 41. The plurality of lever arms comprises a first lever arm 3 and a second lever arm 7. The first lever arm 3 comprises a pivot 4, a pivot 5, and a pivot 6. The second lever arm 7 comprises a pivot 8, a pivot 9, and a pivot 10. The pivots may take the form of ball bearings. The first mounting plate 31 may be attached to the first lever arm 3 at pivot 6. The second mounting plate 41 may be attached to the second lever arm 7 at pivot 10.

As shown in FIG. 4, the actuator 51 may be fixed to the second lever arm 7 at pivot 8. Further, the actuator 51 comprises an actuator arm 53, wherein a terminal end of the actuator arm 53 may be attached to the first lever arm 3 at pivot 4. The actuator 51 can further comprise sensors (not shown) such as a load cell, a hydraulic cylinder, and/or a linear sensor.

The brake support structure 21 may attach to the first lever arm 3 at pivot 5 and may attach to the second lever arm 7 at pivot 9. The brake support structure 21 may be rigid and may maintain the second pivots 5, 9 at a fixed distance.

More specifically, FIG. 4 shows an exemplary embodiment of the first hydraulic actuated clamp 1 in the closed position. In the closed position, the actuator arm 53 may be extended, applying a first force to the first lever arm (or caliper) 3 at pivot 4. The first force causes pivot 4 to move upwardly, relative to pivot 5. Pivot 5 of the first lever arm 3 is fixed in place, relative to the pod 200, by the brake support structure 21 and first linkage 25 and second linkage (not shown). The first lever arm (or caliper) 3 rotates counter-clockwise about fixed pivot 5, which displaces pivot 6 downwardly and towards the first brake rail 101. Displacement of the pivot 6 causes the first mounting plate 31 to move towards the first brake rail 101, which in turn, causes the first plurality of brake pads 32 to apply a first braking force to an upper side of the first brake rail 101.

Additionally, the actuator 51 is structured and arranged to produce a second force—of equal magnitude and opposite direction of the first force—to a second lever arm (or caliper) 7 at pivot 8. The second force may cause pivot 8 to move downwardly, relative to pivot 9. Pivot 9 of the second lever arm 7 is fixed in place, relative to the pod 200 by the brake support structure 21 and first linkage and second linkage (not shown). The second lever arm 7 rotates clockwise about fixed pivot 9, which displaces the pivot 10 upwardly and towards the first brake rail 101. Displacement of pivot 10 causes the second mounting plate 41 to move towards the first brake rail 101, which in turn, causes the second plurality of brake pads 42 to apply a second braking force to a lower side of the first brake rail 101.

To improve and monitor operation of the braking apparatus, a plurality of sensors may be, e.g., imbedded, in the actuator 51. The plurality of sensors may comprise, for example and without limitation, an electromagnetic linear strip to measure displacement of the actuator rod, and a load cell in series with the actuator to measure and determine the force output by the actuator (which can be used to determine the force that the braking apparatus applies to the brake rail). In conjunction with the hydraulic cylinder linear sensor and the load cell measurement, in embodiments, a global wear rate of the brake pads can be sensed and the brake pressure can easily be adjusted in a closed loop control system.

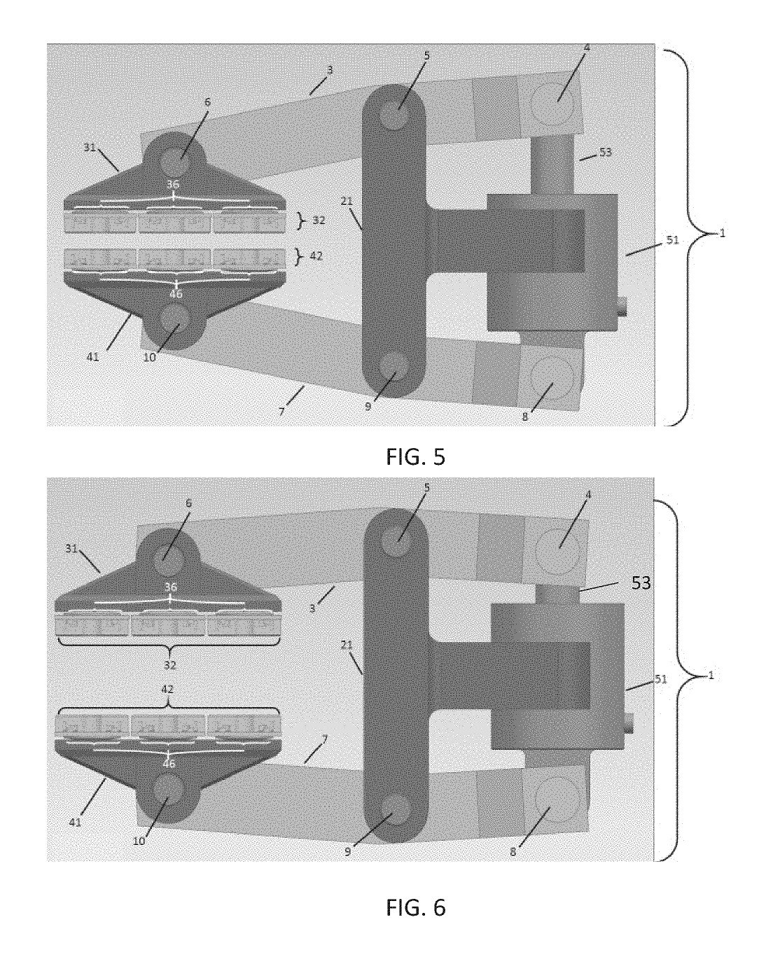

FIG. 5 shows the exemplary braking apparatus in a first position in accordance with aspects of the disclosure. More specifically, FIG. 5 shows an exemplary hydraulic actuated clamp 1 in a closed position in accordance with aspects of the disclosure. As shown in FIG. 5, in the closed position, the actuator arm 53 is extended, applying a first force to the first lever arm 3 causing the first lever arm 3 to rotate counter-clockwise about fixed pivot 5, which causes the first mounting plate 31 to move towards the first brake rail 101, which in turn, causes the first plurality of brake pads 32 to apply a first braking force to an upper side of the first brake rail 101. Additionally, as shown in FIG. 5, the actuator 51 is structured and arranged to produce a second force, of approximately equal magnitude and opposite direction of the first force to a second lever arm 7, causing the second lever arm 7 to rotates clockwise about fixed pivot 9, which causes the second mounting plate 41 to move towards the first brake rail 101, which in turn, causes the second plurality of brake pads 42 to apply a second braking force to a lower side of the first brake rail 101.

FIG. 6 shows the exemplary braking apparatus in a second position in accordance with aspects of the disclosure. In accordance with aspects of the disclosure, FIG. 6 shows the hydraulic actuated clamp 1 in an open position. In an open position, the clamp 1 does not contact the brake rail 101. As can be observed in FIG. 6, in the open position, the actuator arm 53 has receded within the actuator 51, causing the opening of the clamp 1 between the first plurality of brake pads 32 and the second plurality of brake pads 42.

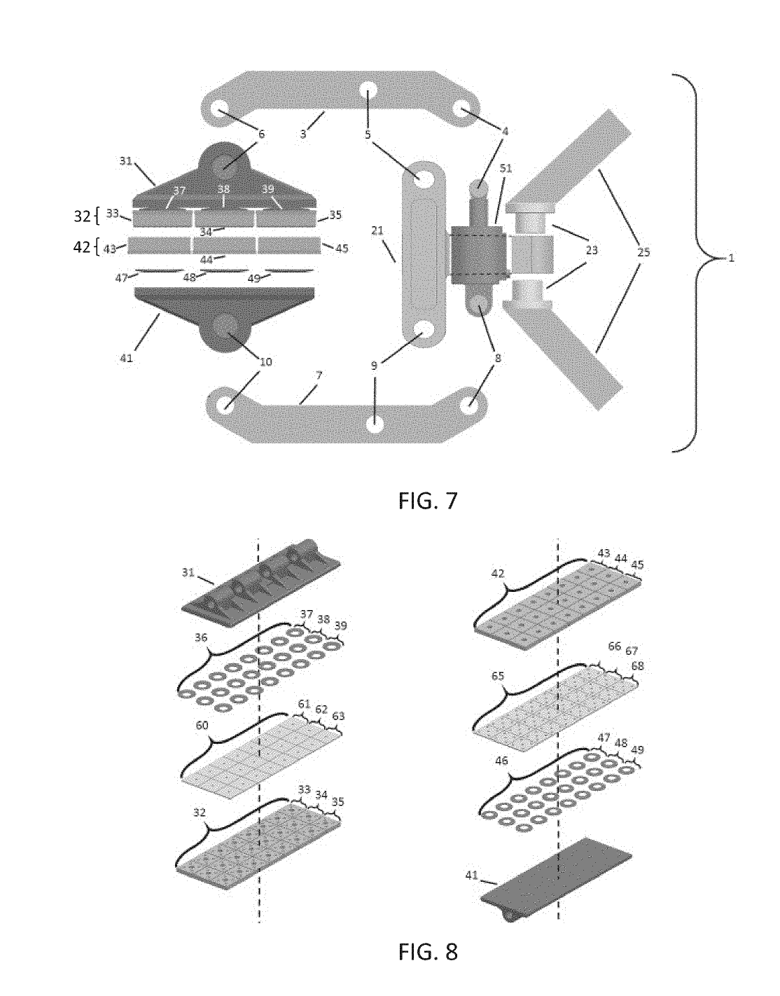

FIG. 7 shows an exploded view of the exemplary braking apparatus in accordance with aspects of the disclosure. In embodiment, the one or more structural mounting plates may further comprise one or more braking pads. The one or more braking pads may be configured to be aligned in multiple rows and columns and may rotate about a central axis. Rotation of the one or more braking pads may be limited due to the one or more disk springs attached to the one or more braking pads and one or more structural mounting plates. The one or more disk springs may be located on the backing plate. The one or more disk springs may be substantially recessed into the backing plate of each braking pad to allow slight flexure of the disk spring in any radial direction while retaining the spring about the central axis.

FIG. 7 shows an exploded view of the hydraulic actuated clamp 1, including the first and second pluralities of braking pads 32, 42 and the first and second pluralities of disk springs 36, 46. With this exemplary and non-limiting embodiment, the first plurality of braking pads 32 comprises a first row 33 of braking pads 32, a second row 34 of braking pads 32, and a third row 35 of braking pads 32. The second plurality of braking pads 42 comprises a fourth row 43 of braking pads 42, a fifth row 44 of braking pads 42, and a sixth row 45 of braking pads 42. With this exemplary and non-limiting embodiment, the first plurality of disk springs 36 comprises a first row 37 of disk springs 36, a second row 38 of disk springs 36, and a third row 39 of disk springs 36. The second plurality of disk springs 46 comprises a fourth row 47 of disk springs 46, a fifth row 48 of disk springs 46, and a sixth row 49 of disk springs 46.

In accordance with aspects of the disclosure, the one or more brake pads and the one or more disk spring can compensate for miniscule angle changes, thickness variations and any other irregularities in order to ensure consistent pad pressure against a brake rail.

FIG. 7 further shows a first elastomer element 23 and a first linkage 25. The first elastomer element 23 and a second elastomer element 24 (not shown in FIG. 7) may be connected to the brake support structure 21. The first elastomer element 23 may be further attached to the first linkage 25 and the second elastomer element 24 may be connected to a second linkage (not shown), wherein the first linkage 25 and the second linkage are further attached or connectable to a pod (not shown).

FIG. 8 shows an exploded view of elements of the braking apparatus in accordance with aspects of the disclosure. A rail system may experience high- and/or low-frequency deflection, especially, for example, sinusoidal deflection due to gravity sag when the transportation tube is elevated on pylons. This deflection may affect a braking system's ability to maintain contact with the rail. In accordance with aspects of the disclosure, the one or more brake pads and the one or more disk spring can compensate for miniscule angle changes, thickness variations and any other irregularities in order to ensure consistent pad pressure against a brake rail.

FIG. 8 shows an exploded view of the first and second mounting plates 31, 41, the first and second plurality of disk springs 36, 46—comprising the first, second, third, fourth, fifth, and sixth rows of disk springs 37, 38, 39, 47, 48, 49—the first and second plurality of brake pads 32, 42—comprising the first, second, third, fourth, fifth, and sixth rows of braking pads 33, 34, 35, 43, 44, 45—a first plurality of pad backing plates 60, and a second plurality of pad backing plates 65. Wherein the first plurality of pad backing plates 60 comprises a first row 61, a second row 62, and a third row 63 of pad backing plates 60 and the second plurality of pad backing plates 65 comprises a fourth row 66, a fifth row 67, and a sixth row 68 of pad backing plates 65.

Brake pads 32, 42 of the first, second, third, fourth, fifth, and sixth rows of braking pads 33, 34, 35, 43, 44, 45 may be fixed to respective pad backing plates of the first, second, third, fourth, fifth, and sixth rows of pad backing plates 61, 62, 63, 66, 67, 68, forming a first, second, third, fourth, fifth, and sixth row of combination brake pad & pad backing plate.

With this exemplary and non-limiting embodiment, the first, second, and third rows of disk springs 37, 38, 39 may be attached to respective first, second, and third rows of recesses (not shown) in the first mounting plate 31 and the fourth, fifth, and sixth rows of disk springs 47, 48, 49 attach to a fourth, fifth, and sixth rows of recesses in the second mounting plate 41. In embodiments, the plurality of mounting plates, disk springs, pad backing plates, and brake pads may be held together by a plurality of shear pins (not shown).

In accordance with aspects of the disclosure, the first, second, third, fourth, fifth, and sixth rows of combination brake pad & pad backing plate are operable to independently move so as to conform to the first, second, third, fourth, fifth, and sixth rows of disk springs 37, 38, 39, 47, 48, 49 so as to, for example, maintain contact with a brake rail.

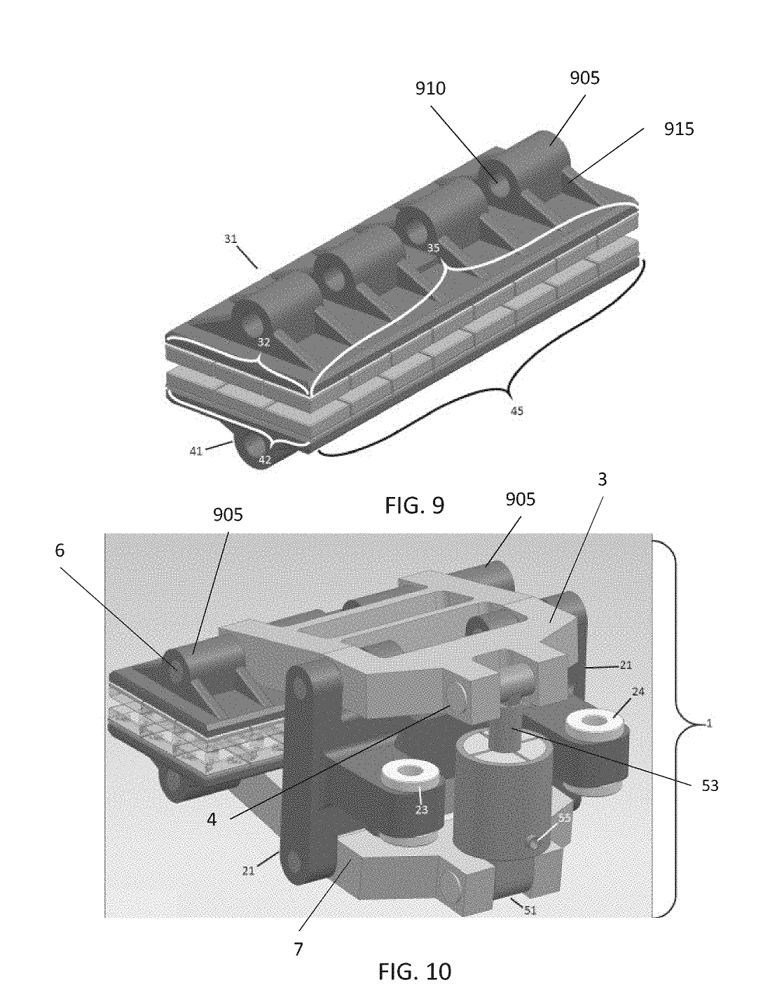

FIG. 9 shows an isometric view of elements of the exemplary braking apparatus in accordance with aspects of the disclosure. More specifically, FIG. 9 shows an isometric view of the first and second mounting plates 31, 41 having respective braking pads 32, 42. As shown in FIG. 9, the respective braking pads 32, 42 comprise rows of braking pads (e.g., 35, 45), which provide a braking surface for contact with a respective brake rail (not shown). As shown in FIG. 9, mounting plate 31 (and mounting plate 41) includes a plurality of attachment pivots 905 having respective holes 910 and bracing 915.

FIG. 10 shows an isometric view of the exemplary braking apparatus in accordance with aspects of the disclosure. For example, FIG. 10 shows an isometric view of the hydraulic actuated clamp 1 and shows how the first and second elastomer elements (e.g., rings, cylinders, or ring-like elements) 23, 24 are conformable to the brake support structure 21. In accordance with aspects of the disclosure, elastomeric rings at the pod/caliper connection may minimize deflections and/or vibration transmission. FIG. 10 additionally shows the actuator 51 may additionally comprise an input/output port 55 whereby at least one tube (e.g., hydraulic and or pneumatic) and/or at least one wire (e.g., power, signal, and/or control wires) may connect the actuator 51 to the pod 200 (e.g., to a control system onboard the pod and/or in communication with the pod). The actuator 51 may further comprise an electromagnetic linear strip (not shown) to measure displacement of the actuator arm 53 and a load cell (not shown) to measure an actuation force, and which may subsequently be used to calculate (e.g., in real-time) a force applied by the first and second plurality of braking pads 32, 42 onto the first braking rail (not shown).

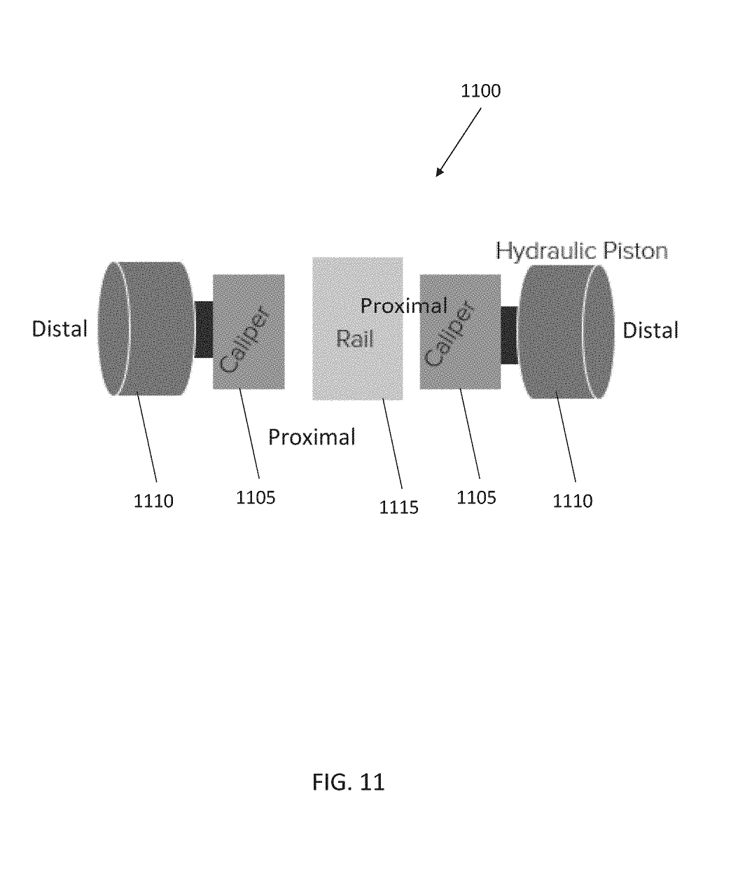

FIG. 11 shows a schematically-depicted cross-sectional view of an exemplary braking apparatus 1100 in accordance with aspects of the disclosure. As shown in FIG. 11, the at least one braking assembly 1100 may comprise two calipers 1105, two brake pads (not shown) arranged on faces of the calipers 1105, and two hydraulic pistons 1110. The two brake pads (not shown) may be located on a proximal surface of the two calipers 1105, such that one brake pad is installed on each of the two calipers 1105. The two hydraulic pistons 1110 may be located on a distal surface of the two calipers 1105, such that one hydraulic piston 1110 is provided for each of the two calipers 1105. The two hydraulic pistons 1110 may act on the two calipers 1105, such that the two calipers 1105 are pushed inwards, towards the rail 1115. In accordance with aspects with the disclosure, the inward movement of the calipers brings the two brake pads in contact with a mating material. The mating material may be a proximal portion of the surface the vehicle is travelling on (or adjacent to). The surface the vehicle is travelling on (or adjacent to) may be a rail (e.g., a brake rail). The mating material may be structured and arranged to be located in between the two calipers.

As the vehicle (not shown) continues to move along the rail 1115, the two brake pads may maintain contact with the rail, thus creating a friction between the mating material and the two brake pads, which in turn causes the velocity of the vehicle to decrease. The movement of the vehicle (not shown) along the rail 1115 may prevent the brake pads from contacting a substantially same portion of the rail for an extended amount of time, which may in turn reduce the amount of heat the mating material of the brake rail is subjected to.

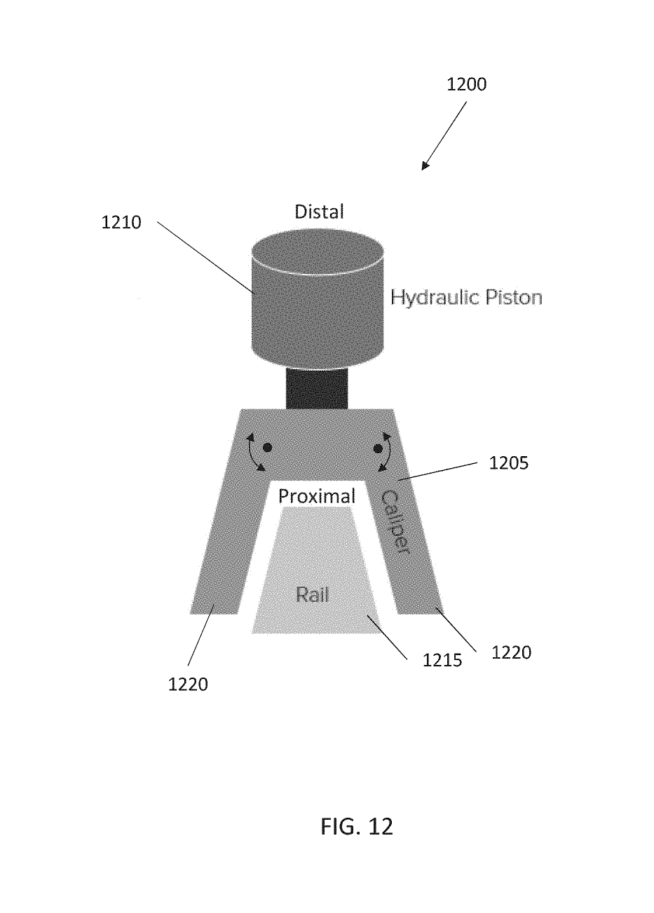

FIG. 12 shows a schematically-depicted cross-sectional view of an exemplary braking assembly 1200 in accordance with aspects of the disclosure. As shown in FIG. 12, the exemplary and non-limiting braking assembly 1200 may comprise a caliper 1205, at least one brake pad (not shown), and a hydraulic piston 1210, wherein the braking assembly 1200 is selectively engagable with a mating material (not shown). As shown in FIG. 12, with this schematically-depicted exemplary embodiment, the caliper 1205 may comprise two arms 1220 which extend substantially longitudinally from a proximal surface of the caliper 1205. The one or more brake pads may be located on a proximal surface of each of the two arms 1220 of the caliper 1205. The hydraulic piston 1210 may be located on a distal surface of the caliper 1205. The mating material (not shown) may be arranged on a proximal portion of the surface the vehicle and attached to the braking assembly 1200 is travelling on or adjacent to. In embodiments, the surface the vehicle is travelling on (or adjacent to) may comprise a rail 1215 (e.g., a brake rail). As shown in FIG. 12, with this exemplary embodiment, the rail 1215 may be structured and arranged to be located in between the two arms 1220 of the caliper 1205.

In the event the vehicle may need to be slowed, with this schematically-depicted exemplary embodiment, the hydraulic piston 1210 may act upon the caliper 1205, causing the caliper 1205 to contract the two arms 1220 around the brake rail 1215. This contraction of the two arms 1220 causes the respective brake pads (not shown) to contact the rail 1215. As the vehicle (not shown) continues to move along the rail 1215, the two brake pads (not shown) may maintain contact with the rail 1215, thus creating a frictional force between the mating material and the brake pad, which in turn causes the velocity of the vehicle to decrease. The movement of the vehicle (not shown) along the rail 1215 may prevent the brake pad from contacting a substantially same portion of the rail for an extended amount of time, which may in turn reduce the amount of heat on the mating material.

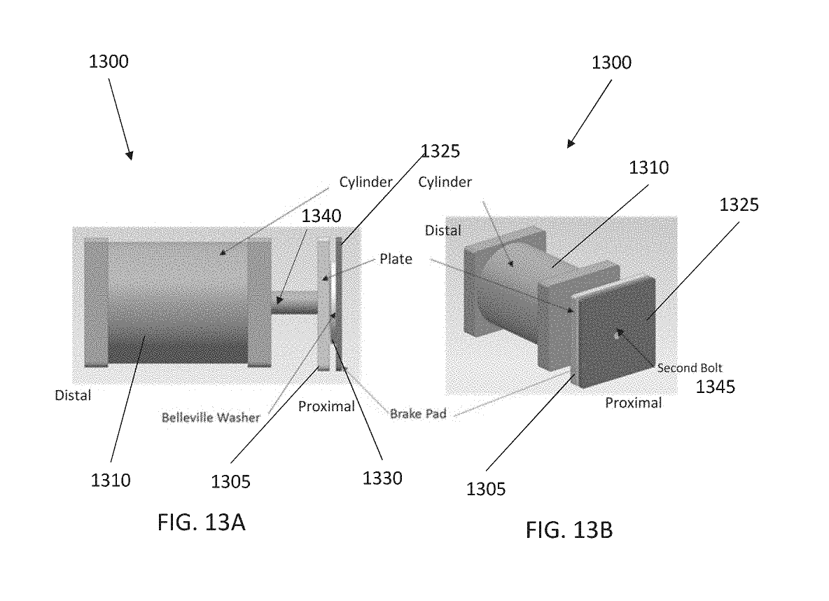

FIGS. 13A and 13B show a side view and a front perspective view of an exemplary braking assembly 1300 in accordance with aspects of the disclosure. Aspects of the present disclosure are directed to a system for braking comprising at least one brake rail and at least one caliper, for example using a plurality of braking assemblies 1300. In this exemplary embodiment, the at least one brake rail (not shown) may be composed of metal. The at least one brake rail may be affixed to the surface (e.g., tube interior surface) the vehicle is travelling on (and/or above and/or through).

In one exemplary embodiment, as shown in FIG. 13A, the braking assembly 1300 may comprise a cylinder 1310, at least one brake pad 1325, a plate 1305, a Belleville washer 1330, and a first bolt (or piston rod of the cylinder) 1340. As shown in FIGS. 13A and 13B, the cylinder 1310 may be located on the distal portion of the braking assembly 1300. The cylinder 1310 may comprise, but is not limited to, a hydraulic or pneumatic cylinder. The first bolt (or piston rod) 1340 may extend from a proximal surface of the cylinder 1310 and terminate in a distal surface of the plate 1305. As shown in FIG. 13A, the brake pad 1325 may be located on a proximal portion of the plate 1305, with a Belleville washer 1330 arranged substantially in between the plate 1305 and the brake pad 1325 (e.g., between the plate 1305 and the brake pad 1325 across a substantial area of the plate 1305).

In accordance with aspects of the disclosure, in this exemplary and non-limiting embodiment, the at least one Belleville washer 1330 may act like a spring and compress, allowing the brake pad (or plate underlying the brake pad) to rotate and/or pivot in order to increase the ability of the at least one brake pad 1325 of each braking assembly to maintain contact with the brake rail (not shown). A Belleville washer 1330 is a type of spring, a coned-disc spring shaped like a washer having a frusto-conical shape. In embodiments, the at least one Belleville washer may act like a spring, such as by having multiple washers in a parallel, series, or parallel-series stack, enabling compression in the direction perpendicular to the braking assembly surface that comes in contact with the brake rail and allowing the plate 1305 to move bi-axially about the point of connection to the washer (similarly to a condyloid joint), in order to allow the at least one brake pad 1325 of each braking assembly 1300 to maintain contact with the brake rail (not shown).

As shown in FIG. 13B, the braking assembly 1300 may further comprise a second bolt 1345. In this exemplary embodiment, the brake pad 1325 may be rigidly affixed to a proximal surface of the plate 1305 with the Belleville washer 1330 arranged there between, using the second bolt 1345.

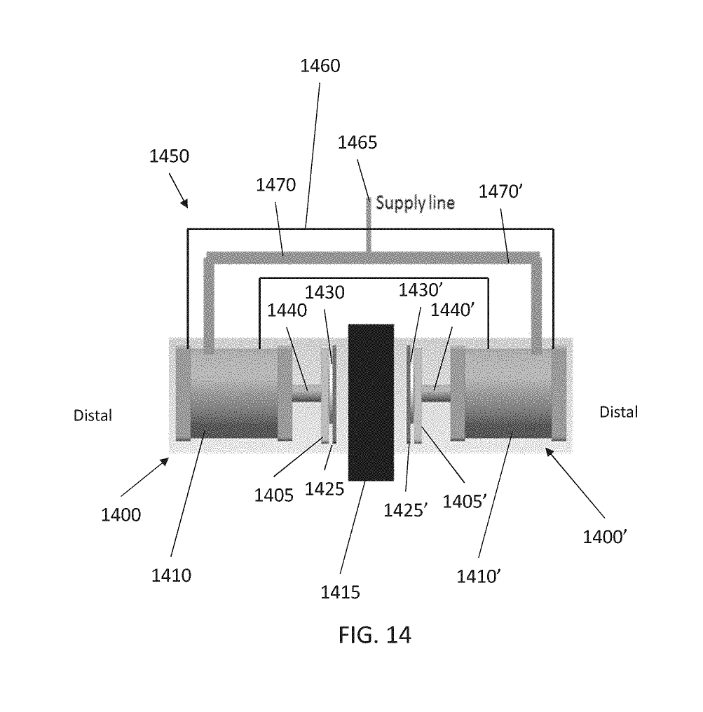

FIG. 14 shows a schematically-depicted cross-sectional view of an exemplary braking apparatus 1450 comprising a plurality of braking assemblies 1400, 1400′. In accordance with aspects of the disclosure, in embodiments, the at least one caliper may comprise two braking assemblies and an actuation line. Each of the two braking assemblies may comprise at least one cylinder, at least one brake pad, at least one plate, at least one Belleville washer, a bolt, and a shear pin. The cylinder may be located on the distal portion of the braking assembly. The cylinder may comprise, but is not limited to, a hydraulic or pneumatic cylinder. The at least one brake pad may be located on a proximal portion of the at least one plate. The at least one brake pad may be rigidly affixed to a proximal surface of the at least one plate via the at least one Belleville washer and the bolt, such that the at least one Belleville washer is positioned substantially between the at least one plate and the at least one brake pad with the bolt securing the at least one brake pad in place. The at least one plate may be connected via a shear pin to the body of the vehicle to transmit deceleration force in the direction of the motion. The at least one brake pad may be made of a material comprising, but not limited to, a carbon-reinforced carbon, a sintered metal, or a combination of a carbon-reinforced carbon and a sintered metal.

The at least one caliper may be further configured such that the at least one brake pad of each of the two braking assemblies is located on either side of the brake rail. When it is necessary for the vehicle to slow, the at least one brake pad of each of the two braking assemblies may be brought into contact with the brake rail by the fast acting valve, creating a frictional force that slows the vehicle. In the event the vehicle deviates from a straight linear movement, e.g., through vibration, the at least one balance line and the at least one Belleville washer may work in conjunction to allow the at least one brake pad of each braking assembly to maintain contact with the brake rail while limiting the pressure rise at contact surface. For example, in the event the vehicle deviates from a straight linear movement due to the path the vehicle takes, e.g. a turn or a dip, one of the cylinder or actuator may contract (or retract), which may cause the other cylinder or actuator to extend, allowing the at least one brake pad of each braking assembly to maintain contact with the brake rail without excessive forces.

As shown in FIG. 14, the braking apparatus 1450 may comprise a caliper 1460 arranged “around” a brake rail 1415. The brake rail 1415 may be positioned such that it is in between the two braking assemblies 1400, 1400′, or conversely, the brake pads 1425, 1425′ of the two braking assemblies 1400, 1400′ may be positioned such that they “surround” the brake rail 1415. As shown in FIG. 14, the at least one caliper 1460 is structured and arranged such that the at least one brake pad 1425, 1425′ of each of the two braking assemblies 1400, 1400′ is located on opposite sides of the brake rail 1415.

With this exemplary embodiment, each of the two braking assemblies 1400 may comprise at least one cylinder 1410, at least one brake pad 1425, at least one plate 1405, at least one Belleville washer 1430, a first bolt 1440, and a second bolt (not shown). The cylinder 1410 may be located on the distal portion of its respective braking assembly 1400. In exemplary and non-limiting embodiments, the cylinder 1410 may comprise, but is not limited to, a hydraulic or pneumatic cylinder. The first bolt 1440 may extend from a proximal surface of the cylinder 1410 and terminate in a distal surface of the at least one plate 1405. The at least one brake pad 1425 may be located on a proximal portion of the at least one plate 1405. The at least one brake pad 1425 may be rigidly affixed to a proximal surface of the at least one plate 1405 along with the at least one Belleville washer 1430 using the second bolt (not shown), such that the at least one Belleville washer 1430 is positioned substantially between the at least one plate 1405 and the at least one brake pad 1425. The second bolt is operable to secure the at least one brake pad 1425 in place. In exemplary embodiments, the at least one brake pad 1425 may be made of a material comprising, but not limited to, a carbon-reinforced carbon, a sintered metal, or a combination of a carbon-reinforced carbon and a sintered metal.

In the event the vehicle (not shown) needs to reduce its speed, the brake pads 1425, 1425′ are operable to move into contact with the brake rail 1415. This contact creates a frictional force that opposes the speed of the vehicle, thereby slowing the vehicle. In some embodiments, at least one brake pad of each of the two braking assemblies may be brought into contract with the brake rail, creating a frictional force that slows the vehicle.

In embodiments, an actuation line may comprise a supply line and a balance line. In embodiments, the supply line is connected to a high pressure source (actuation system) through, for example, a fast acting valve. The actuation line may be configured such that it is perpendicularly connected to each distal end of the supply line. The balance line may work such that the contracting (or retracting) of one cylinder or actuator causes the extending of the other cylinder or actuator. The at least one caliper may be further configured such that the balance line is affixed to a distal portion of each of the two braking assemblies, thus connecting the two braking assemblies. The caliper may be configured such that each end of the balance line may terminate in the cylinder of the two braking assemblies.

For example, as shown in FIG. 14, the caliper 1460 may further comprise a bypass line in communication with the two braking assemblies 1410, 1410′. With the exemplary embodiment, the bypass line may comprise a supply line 1465 and two balance lines 1470, 1470′. As shown in FIG. 14, each balance line 1470, 1470′ is in communication with a distal portion of respective braking assemblies 1400, 1400′, thus connecting the two braking assemblies 1400, 1400′. Each of the two balance lines 1470, 1470′ may terminate in the cylinder 1410, 1410′ of respective braking assemblies 1400, 1400′.

The bypass line may be configured such that one balance line 1470 is connected (e.g., perpendicularly) to a distal end of the supply line 1465. In accordance with aspects of the disclosure, the two balance lines 1470, 1470′ may work in conjunction, such that the contracting (e.g., via a fluid) in one balance line causes the extending (e.g., via of a fluid) in the other balance line. A proximal portion of each balance line 1470, 1470′ is in communication with distal portions of respective braking assemblies 1400, 1400′, thus connecting the two braking assemblies 1400, 1400′ at the respective cylinders 1410, 1410′ of each of the two braking assemblies 1400, 1400′.

In accordance with aspects of the disclosure, in the event the vehicle deviates from a straight linear path one of the two balance lines 1470, 1470′ may contract, causing the other balance line 1470′, 1470 to extend, allowing the at least one brake pad 1425, 1425′ of each braking assembly 1400, 1400′ to maintain contact with the brake rail 1415. The movement of the two balance lines 1470, 1470′ may be dependent on the type of cylinder used. For example, if pneumatic cylinders are used, then pressure may transfer from one balance line to the other balance line via the supply line. In another example, if hydraulic cylinders are used, the fluid from the contracting balance line may move through the supply line to the other balance line, causing the other balance line to extend. In such a manner, in accordance with aspects of the disclosure, even if the brake apparatus 1450 may not be completely centered “around” the rail 1415 (e.g., due to lateral shift and/or vertical shift), the braking apparatus 1450 is still able to apply a sufficient braking force. In the event the vehicle deviates from a straight linear movement, for example, due to the path the vehicle takes, e.g., a turn or a dip (e.g., due to flexing), one of the balance lines 1470, 1470′ may contract, which may cause the other balance line 1470′, 1470 to extend, allowing the at least one brake pad of each braking assembly 1400, 1400′ to maintain contact with the brake rail 1415 when the braking assembly 1400 is applied.

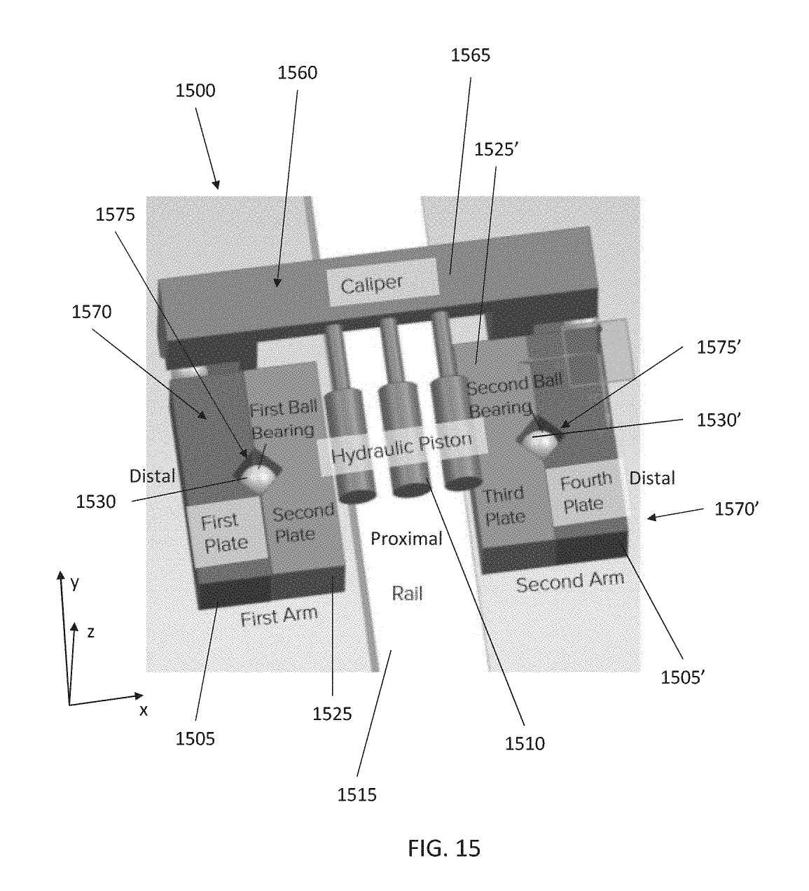

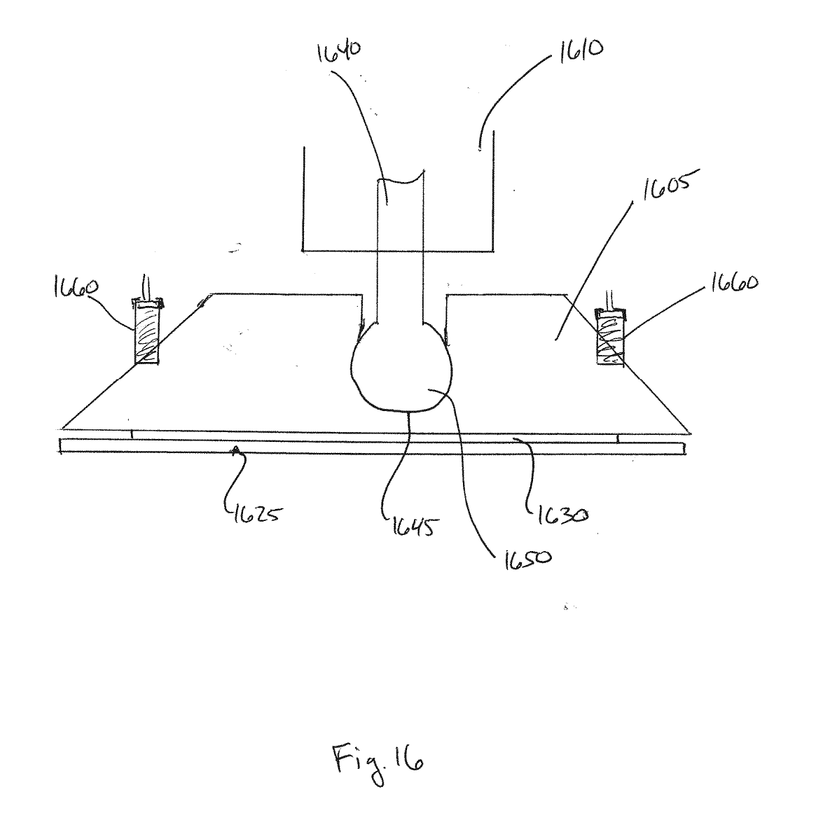

FIG. 15 shows a view of another embodiment of an exemplary braking assembly 1500 in accordance with aspects of the disclosure. As shown in FIG. 15, with this exemplary and non-limiting embodiment, the at least one braking assembly 1500 comprises a caliper 1560, a first brake pad (not shown), a second brake pad (not shown), and multiple hydraulic pistons 1510. The first brake pad (not shown) may be located on a proximal surface of the second plate 1525. The caliper 1560 may comprise: a body 1565, a first arm 1570, a second arm 1570′, a first ball bearing 1530, and a second ball bearing 1530′. The first arm 1570 and the second arm 1570′ may extend longitudinally from the body 1565 of the caliper 1560. The first arm 1570 may comprise a first plate 1505 and a second plate 1525. As shown in FIG. 15, the first plate 1505 and the second plate 1525 may be structured and arranged to interconnect. With this exemplary embodiment, the first plate 1505 and second plate 1525 may form a cavity 1575 substantially in between a proximal portion of the first plate 1505 and a distal portion of the second plate 1525. The first ball bearing 1530 may be arranged in the cavity 1575.

The second arm 1570′ may comprise a third plate 1525′ and a fourth plate 1505′. The third plate 1525′ and a fourth plate 1505′ may be structured and arranged to interconnect. The third plate 1525′ and a fourth plate 1505 ‘may form a cavity 1575’ substantially in between a distal portion of the third plate 1525′ and a proximal portion of the fourth plate 1505′. The second ball bearing 1530′ may be arranged in the cavity 1575′.

As shown in FIG. 15, the multiple hydraulic pistons 1510 may be located on the body of the caliper 1560, substantially in between the first arm 1570 and the second arm 1570′. The surface the vehicle is travelling on may comprise a rail 1515. A mating material may be located on a proximal portion of the surface (e.g., rail, such as a brake rail) the vehicle is travelling on (or along). The rail 1515 may be structured and arranged to be located substantially in between the second plate 1525 and the third plate 1525′. In the event the vehicle (not shown) may need to be slowed, the multiple hydraulic pistons 1510 may contract, causing the first plate 1505 and the fourth plate 1505′ to move upwards (i.e., in the y-direction). The movement of the first plate 1505 in the y-direction causes the first ball bearing 1530 to press on a distal portion of the second plate 1525, urging the second plate 1525 in the x-direction, which in turn causes the first brake pad (not shown) to contact the rail 1515 (e.g., move in the x-direction). Likewise, the movement of the fourth plate 1505′ causes the second ball bearing 1530′ to press on a distal portion of the third plate 1525′, urging the third plate 1525′ in an opposite x-direction, which then causes the second brake pad (not shown) to contact the rail 1515. In accordance with aspects of the disclosure, a frictional force is created when the first brake pad and the second brake pad contact the rail 1515. For example, as the vehicle continues to move along the rail 1515 with the brake pads engaged, the two brake pads may maintain contact with the rail 1515, thus creating friction between the mating material (e.g., on or in the rail) and the two brake pads (not shown), which in turn causes the velocity of the vehicle (not shown) to decrease. In accordance with aspects of the disclosure, the movement of the vehicle along the rail 1515 may prevent the two brake pads from contacting a substantially same portion of the rail 1515 for an extended amount of time, which may in turn reduce the amount of heat on the mating material.

FIG. 16 shows a cross-sectional view of an exemplary braking assembly 1600 in accordance with aspects of the disclosure. As shown in FIG. 16, the braking assembly 1600 may comprise a cylinder 1610, a brake pad 1625, a plate 1605, a Belleville washer 1630, a gimbal 1650, and a bolt 1640 (or piston rod of the cylinder). The cylinder 1610—may be arranged on the distal portion of the braking assembly 1600. The cylinder 1610 may comprise, but is not limited to, a hydraulic or pneumatic cylinder. The bolt 1640 may extend from a proximal surface of the cylinder 1610 and terminate in the gimbal 1650. The at least one gimbal 1650 may connect the first bolt 1640 to a distal surface of the at least one plate 1605. In embodiments, the gimbal 1650 may be arranged in a cavity 1645 in a distal surface of the plate 1605.

As shown in FIG. 16, the brake pad 1625 may be arranged on a proximal portion of the plate 1605, with the Belleville washer 1630 substantially in between the plate 1605 and the brake pad 1625 (e.g., between the plate 1605 and the brake pad 1625 across a substantial area of the plate 1605). In further embodiments (not shown), the at least one brake pad 1625 may be rigidly affixed to a proximal surface of the at least one plate 1605 (e.g., without an intervening Belleville washer 1630). In exemplary embodiments, the at least one brake pad 1625 may be made of a material comprising, but not limited to, a carbon-reinforced carbon, a sintered metal, or a combination of a carbon-reinforced carbon and a sintered metal.

In accordance with aspects of the disclosure, in the event the vehicle (not shown) deviates from a straight linear movement through vibration, for example, the at least one gimbal 1650 and the at least one Belleville washer 1630 may work in conjunction to allow the at least one brake pad 1625 of each braking assembly 1600 to maintain contact with the brake rail (not shown). For example, in accordance with aspects of the disclosure, in this embodiment, the at least one gimbal 1650 may act as a ball joint and allow the plate 1605 to rotate and/or pivot relative to the bolt 1640 in order to enhance the ability of the at least one brake pad 1625 of each braking assembly 1600 to maintain contact with the brake rail (not shown). Additionally, the at least one Belleville washer 1630 allows further relative movement between the plate 1605 and the at least one brake pad 1625 allowing the brake pad 1625 to rotate and/or pivot relative to the plate 1605 in order to enhance the ability of the at least one brake pad 1625 of each braking assembly 1600 to maintain contact with the brake rail (not shown). As further shown in FIG. 16, the braking assembly 1600 may include a plurality of shock absorbers (or dampers) 1660 structured and arranged to connect between the plate 1605 and another portion of the braking assembly 1600, and configured to suppress relative movement of the plate 1605.

### System Environment

Aspects of embodiments of the present disclosure (e.g., control systems for a braking apparatus) can be implemented by such special purpose hardware-based systems that perform the specified functions or acts, or combinations of special purpose hardware and computer instructions and/or software, as described above. The control systems may be implemented and executed from either a server, in a client server relationship, or they may run on a user workstation with operative information conveyed to the user workstation. In an embodiment, the software elements include firmware, resident software, microcode, etc.

As will be appreciated by one skilled in the art, aspects of the present disclosure may be embodied as a system, a method or a computer program product. Accordingly, aspects of embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure (e.g., control systems) may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following:

an electrical connection having one or more wires,

a portable computer diskette,

a hard disk,

a random access memory (RAM),

a read-only memory (ROM),

an erasable programmable read-only memory (EPROM or Flash memory),

an optical fiber,

a portable compact disc read-only memory (CDROM),

an optical storage device,

a transmission media such as those supporting the Internet or an intranet,

a magnetic storage device

a usb key, and/or

a mobile phone.

In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network. This may include, for example, a local area network (LAN) or a wide area network (WAN), or the connection may be made to an external computer (for example, through the Internet using an Internet Service Provider). Additionally, in embodiments, the present invention may be embodied in a field programmable gate array (FPGA).

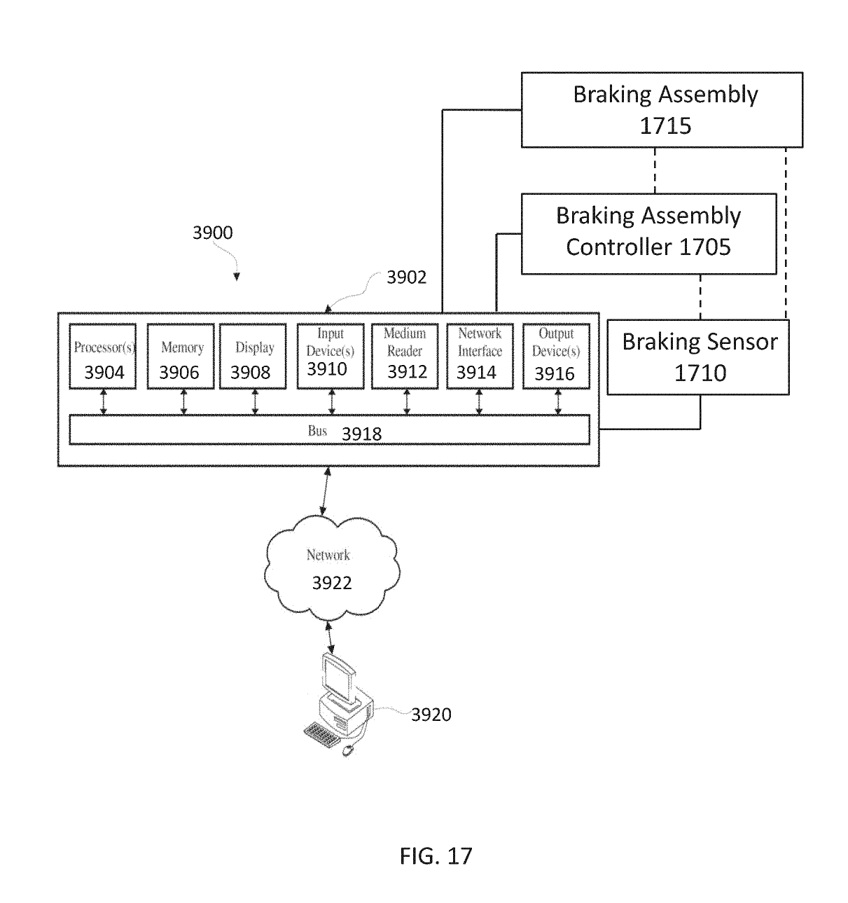

FIG. 17 is an exemplary system for use in accordance with the embodiments described herein. The system 3900 is generally shown and may include a computer system 3902, which is generally indicated. The computer system 3902 may operate as a standalone device or may be connected to other systems or peripheral devices. For example, the computer system 3902 may include, or be included within, any one or more computers, servers, systems, communication networks or cloud environment.

The computer system 3902 may operate in the capacity of a server in a network environment, or in the capacity of a client user computer in the network environment. The computer system 3902, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless telephone, a personal trusted device, a web appliance, or any other machine capable of executing a set of instructions (sequential or otherwise) that specify actions to be taken by that device. Further, while a single computer system 3902 is illustrated, additional embodiments may include any collection of systems or sub-systems that individually or jointly execute instructions or perform functions.

As illustrated in FIG. 17, the computer system 3902 may include at least one processor 3904, such as, for example, a central processing unit, a graphics processing unit, or both. The computer system 3902 may also include a computer memory 3906. The computer memory 3906 may include a static memory, a dynamic memory, or both. The computer memory 3906 may additionally or alternatively include a hard disk, random access memory, a cache, or any combination thereof. Of course, those skilled in the art appreciate that the computer memory 3906 may comprise any combination of known memories or a single storage.

As shown in FIG. 17, the computer system 3902 may include a computer display 3908, such as a liquid crystal display, an organic light emitting diode, a flat panel display, a solid state display, a cathode ray tube, a plasma display, or any other known display. The computer system 3902 may include at least one computer input device 3910, such as a keyboard, a remote control device having a wireless keypad, a microphone coupled to a speech recognition engine, a camera such as a video camera or still camera, a cursor control device, or any combination thereof. Those skilled in the art appreciate that various embodiments of the computer system 3902 may include multiple input devices 3910. Moreover, those skilled in the art further appreciate that the above-listed, exemplary input devices 3910 are not meant to be exhaustive and that the computer system 3902 may include any additional, or alternative, input devices 3910.

The computer system 3902 may also include a medium reader 3912 and a network interface 3914. Furthermore, the computer system 3902 may include any additional devices, components, parts, peripherals, hardware, software or any combination thereof which are commonly known and understood as being included with or within a computer system, such as, but not limited to, an output device 3916. The output device 3916 may be, but is not limited to, a speaker, an audio out, a video out, a remote control output, or any combination thereof.

In accordance with aspects of the disclosure, the system 3900 may also include a braking assembly controller 1705 in communication with the computer system 3902. As shown in FIG. 17, the braking assembly controller 1705 is in communication with at least one braking assembly 1715 (e.g., a braking assembly and/or braking apparatus discussed herein). As also shown in FIG. 17, the braking assembly controller 1705 is in communication with at least one braking sensor (e.g., load sensor, speed sensor, etc.).

Furthermore, the aspects of the disclosure may take the form of a computer program product accessible from a computer-usable or computer-readable medium providing program code for use by or in connection with a computer or any instruction execution system. The software and/or computer program product can be implemented in the environment of FIG. 17. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable storage medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disc-read/write (CD-R/W) and DVD.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Accordingly, the present disclosure provides various systems, structures, methods, and apparatuses. Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular materials and embodiments, embodiments of the invention are not intended to be limited to the particulars disclosed; rather the invention extends to all functionally equivalent structures, methods, and uses such as are within the scope of the appended claims.

While the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk, tapes or other storage device to capture carrier wave signals such as a signal communicated over a transmission medium. Accordingly, the disclosure is considered to include any computer-readable medium or other equivalents and successor media, in which data or instructions may be stored.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

While the disclosure has been described with reference to specific embodiments, those skilled in the art will understand that various changes may be made and equivalents may be substituted for elements thereof without departing from the true spirit and scope of the disclosure. While exemplary embodiments are described above, it is not intended that these embodiments describe all possible forms of the embodiments of the disclosure. Rather, the words used in the specification are words of description rather than limitation, and it is understood that various changes may be made without departing from the spirit and scope of the disclosure. In addition, modifications may be made without departing from the essential teachings of the disclosure. Furthermore, the features of various implementing embodiments may be combined to form further embodiments of the disclosure.

While the specification describes particular embodiments of the present disclosure, those of ordinary skill can devise variations of the present disclosure without departing from the inventive concept.

Insofar as the description above and the accompanying drawing disclose any additional subject matter that is not within the scope of the claims below, the embodiments are not dedicated to the public and the right to file one or more applications to claim such additional embodiments is reserved.

What is claimed is:

1. A friction-braking apparatus for a transportation system, comprising:
at least one caliper;
at least one piston structured and arranged to move the at least one caliper; and
at least one brake pad connected to the at least one caliper;
wherein the at least one caliper is structured and arranged to selectively move the at least one brake pad into engagement with at least one rail of the transportation system.

2. The friction-braking apparatus according to claim 1, further comprising at least one mounting plate arranged on an end of the at least one caliper, wherein the at least one brake pad is arranged on the at least one mounting plate.

3. The friction-braking apparatus according to claim 2, further comprising at least one gimbal arranged between the mounting plate and the at least one brake pad.

4. The friction-braking apparatus according to claim 3, wherein the at least one gimbal comprises a Belleville washer.

5. The friction-braking apparatus according to claim 2, wherein the at least one brake pad comprises an array of brake pads arranged on the at least one mounting plate.

6. The friction-braking apparatus according to claim 1, wherein the at least one brake pad comprises carbon-reinforced carbon.

7. The friction-braking apparatus according to claim 1, wherein the at least one caliper comprises at least two calipers, and the at least one piston is structured and arranged to move the at least two calipers so as to selectively move the at least one brake pad into engagement with at least one rail of the transportation system.

8. The friction-braking apparatus according to claim 1, wherein the at least one caliper comprises at least two calipers, and the at least one piston is structured and arranged to move the at least two calipers so as to selectively move respective brake pads into engagement with at least one rail of the transportation system.

9. The friction-braking apparatus according to claim 7, further comprising a support structure having first and second pivots structured and arranged for pivotally supporting respective calipers.

10. The friction-braking apparatus according to claim 9, wherein the support structure further comprises a plurality of mounting holes structured and arranged for a connection to a vehicle of the transportation system.

11. The friction-braking apparatus according to claim 10, further comprising elastomer elements arranged in respective mounting holes of the support structure.

12. The friction-braking apparatus according to claim 1, further comprising a mating material arranged on at least portions of the at least one rail.

13. The friction-braking apparatus according to claim 1, wherein the at least one piston comprises two pistons.

14. The friction-braking apparatus according to claim 13, the friction-braking apparatus further comprising a supply line connecting with respective balance lines of the two pistons, wherein the respective balance lines are structured and arranged so cooperatively engage the two pistons in a compensating manner.

15. The friction-braking apparatus according to claim 5, further comprising an array of disk springs, and an array of backing plates, wherein the array of disk springs are arranged in contact with the at least one mounting plate and in respective contact with the array of backing plates, and wherein the array of brake pads are respectively arranged on the array of backing plates.

16. The friction-braking apparatus according to claim 1, wherein the friction-braking apparatus is configured to limit the amount of heat created when reducing a velocity of a vehicle of the transportation system.

17. A transportation tube for a transportation system comprising at least one brake rail structured and arranged for engagement with the at least one friction braking apparatus according to claim 1.

18. A vehicle for a high-speed transportation system comprising at least one friction braking apparatus according to claim 1.

19. The friction-braking apparatus according to claim 1, wherein the at least one brake pad comprises sintered metal.

20. The friction-braking apparatus according to claim 1, wherein the at least one brake pad comprises sintered composite.

21. A method of operating a linear friction-braking apparatus for a vehicle, the method comprising:
selectively moving at least one brake pad of the linear friction-braking apparatus into engagement with at least one rail of a transportation system arranged on a stationary surface of a tubular structure.

22. The method of claim 21, wherein the at least one brake pad comprises at least two brake pads arranged on opposite sides of the at least one rail into of the transportation system, and
wherein the friction-braking apparatus comprises balance lines structured and arranged so cooperatively engage the at least two brake pads arranged on opposite sides of the at least one rail in a compensating manner,
the method further comprising cooperatively engaging the at least two brake pads arranged on opposite sides of the at least one rail in the compensating manner.

23. The method of claim 21, wherein the friction-braking apparatus comprises at least one mounting plate arranged on an end of at least one caliper, wherein the at least one brake pad is arranged on the at least one mounting plate and at least one gimbal is arranged between the mounting plate and the at least one brake pad.
